(19) United States
(12) Patent Application Publication
(10) Pub. No.: US 2018/0006900 A1
(43) Pub. Date: Jan. 4, 2018

(54) PREDICTIVE ANOMALY DETECTION IN COMMUNICATION SYSTEMS

(71) Applicant: Microsoft Technology Licensing, LLC, Redmond, WA (US)

(72) Inventors: Jacek A. Korycki, San Jose, CA (US); David L. Racz, Palo Alto, CA (US)

(21) Appl. No.: 15/197,054

(22) Filed: Jun. 29, 2016

(51) Int. Cl. H04L 12/24; H04Q 9/00; H04W 24/02

(52) U.S. Cl. CPC H04L 41/147; H04W 24/02; H04L 41/064; H04Q 9/00; H04Q 2209/823

(57) ABSTRACT

Systems, methods, and software for operational anomaly detection in communication systems is provided herein. An exemplary method includes obtaining a measured sequence of state information associated with the communications system during a first timeframe, processing the measured sequence of state information to determine a predicted sequence of state information for the communication system during a second timeframe, and monitoring current state information for the communication system over at least a portion of the second timeframe. The method also includes determining operational anomalies associated with the communication system based at least on a comparison between the current state information and the predicted sequence of state information.

### BACKGROUND

Operational telemetry data can be collected by monitoring elements of communication systems, computing systems, software applications, operating systems, user devices, or other devices and systems. The operational telemetry data can indicate a state of operation for various nodes of a communication network, and is typically accumulated into logs or databases over periods of time. The various networks and systems for which telemetry data is observed can include many physical, logical, and virtualized communication elements which might experience problems during operation. These problems can arise from increased traffic, overloaded communication pathways and associated data or communication processing elements, as well as other sources of issues. However, detection of problems with large communication systems can be difficult. These problems can be especially difficult to detect when the communication systems include geographically distributed computing and communication systems, such as employed in large multi-user network conferencing platforms.

### Overview

Systems, methods, and software for operational anomaly detection in communication systems is provided herein. An exemplary method includes obtaining a measured sequence of state information associated with the communications system during a first timeframe, processing the measured sequence of state information to determine a predicted sequence of state information for the communication system during a second timeframe, and monitoring current state information for the communication system over at least a portion of the second timeframe. The method also includes determining operational anomalies associated with the communication system based at least on a comparison between the current state information and the predicted sequence of state information.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an anomaly detection environment in an example.

FIG. 2 illustrates a method of anomaly detection in an example.

FIG. 3 illustrates recurrent neural network processing examples.

FIG. 4 illustrates recurrent neural network processing examples.

FIG. 5 illustrates recurrent neural network processing examples.

FIG. 6 illustrates a computing system suitable for implementing any of the architectures, processes, and operational scenarios disclosed herein.

### DETAILED DESCRIPTION

Operational telemetry data can be collected by monitoring elements of communication systems, computing systems, software applications, operating systems, user devices, or other devices and systems. The operational telemetry data can indicate a state of operation for various nodes of a communication network, and is typically accumulated into logs or databases over periods of time. Detection of problems and anomalies with communication systems can be difficult when the communication systems include geographically distributed computing and communication systems, such as employed in large multi-user network conferencing platforms. For example, communications related to Skype for Business and other network telephony and conferencing platforms can transit many communication elements which transport user traffic over various elements of the Internet, packet networks, private networks, or other communication networks and systems.

The various examples herein discuss enhanced anomaly detection in communication systems, or other computing systems. These anomalies can indicate deviations from expected behavior of a particular communication system or computing system, which can vary in severity. For example, a deviation from expected behavior can be due to unpredicted traffic or overloading of an affected element, or can instead occur due to lower than expected loading or traffic patterns. Other deviations can exist, and can be detected using the predictive anomaly detection discussed herein. Advantageously, the predictive anomaly detection processes and platforms discussed herein provide the technical effects of faster determination of failures and issues, increased uptime for computer networks and communication systems, automated alerting to operators, and more reliable communication systems, among other technical effects.

In many communications systems, prevailing operating behavior is considered normal. Anomalies indicate system behavior which is undesirable or unpredicted, and can indicate failures, errors, overloading, malicious attacks, or other events. Operators of the communication systems typically have access to a range of real time measurements including performance counters, system events, event logs, streaming operational status, or other telemetry data. For example, for a communication service system, telemetry information can be collected that indicates a number of concurrent user connections, processor utilization, memory utilization, average network latency, and the like for particular nodes or elements of the communication system as well as for the communication system as a whole. The telemetry information can be measured, observed, collected, received, or otherwise accumulated into an anomaly detection platform. Taken together, the telemetry information forms a vector of measurements, which describe the current state of the system. Anomaly detection maps the telemetry information to an anomaly reading. The reading can be categorical, i.e. “normal” vs “anomaly”, or quantitative, such as a number describing the degree or severity of anomaly.

Anomaly detection can take an indicated telemetry measurement vector and compare against a collection of telemetry measurement vectors from a history of the system. Mathematically, this methodology can include assessing a density of a probability distribution of the points in n-dimensional space of real numbers, where each point corresponds to a vector of telemetry measurements. An anomaly can be declared when the density estimate is low, or low enough according to some predetermined threshold. Some example anomaly detection methods include: one-class classification (such as one-class Support Vector Machine), reconstruction error of neural net auto-encoders, clustering approaches such as density-based spatial clustering of applications with noise (DBSCAN), and others. These classical methods can also be applied when the vector being evaluated is expanded to include the history of measurements over time, not just at a single time instance. There is a variety of ways for doing so. One way is to merely concatenate the measurement vectors across a number of equally spaced time instances spanning some time range. Another way is to concatenate averages over a number of intervals. For example, the intervals maybe comprise intervals of last hour, last 10 hours, last 100 hours, among others.

In the examples discussed herein, prediction of a ‘tail’ of a telemetry sequence is determined based on a ‘head’ of the telemetry sequence. Deviation and degree of variation between the prediction and an observed tail can indicate anomalous behavior, among other indications. Anomaly determination is based upon predictions of a future part of a sequence of measurements based on knowledge of a past part of the sequence. If a prediction quality is good, then the anomaly detection system concludes the system is behaving normally or nominally. If the prediction quality is significantly off from measured telemetry, the anomaly detection system can declare an anomalous behavior, such as by alerting an operator of the system. The resulting anomaly detection methods are typically interpretable by operators of the system, in part because the predictions are based on predicting outcomes based on past system behavior. The predictions may also serve other needs in addition to anomaly detections. For example, capacity forecasting or aiding expectations of operators ahead of time, even if the predicted events are not aberrations or anomalies.

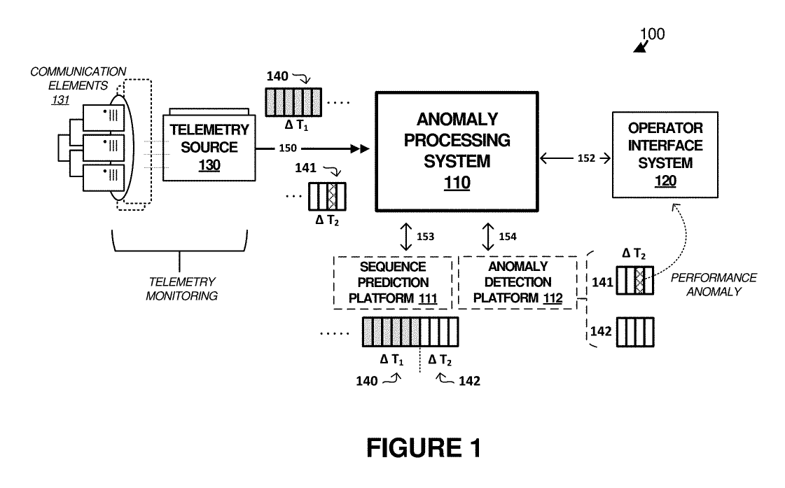

As a first example of telemetry event correlation, FIG. 1 is provided. FIG. 1 illustrates anomaly processing environment 100. Environment 100 includes anomaly processing system 110, sequence prediction platform 111, anomaly detection platform 112, operator interface system 120, telemetry source 130, and communication elements 131. Each of the elements of FIG. 1 can communicate over one or more communication links, such as links 150-154, which can comprise network links, packet links, logical links, or other interfaces. Although some links and associated networks are omitted for clarity in FIG. 1, it should be understood that the elements of environment 100 can communicate over any number of networks as well as associated physical and logical links.

In operation, telemetry source 130 can provide telemetry information, such as sequences of state information related to communication elements, to anomaly processing system 110. This telemetry information can include telemetry data, event data, status data, state information, or other information that can be monitored or measured by telemetry source 130 for associated communication elements which can include software, hardware, or virtualized elements. For example, telemetry source 130 can include application monitoring services which provide a record or log of events associated with usage of associated applications or operating system elements. In other examples, telemetry source 130 can include hardware monitoring elements which provide sensor data, environmental data, user interface event data, or other information related to usage of hardware elements. These hardware elements can include computing systems, such as personal computers, server equipment, distributed computing systems, or can include discrete sensing systems, industrial or commercial equipment monitoring systems, sensing equipment, or other hardware elements. In further examples, telemetry source 130 can monitor elements of a virtualized computing environment, which can include hypervisor elements, operating system elements, virtualized hardware elements, software defined network elements, among other virtualized elements.

The telemetry information, once obtained by anomaly processing system 110 can be analyzed to determine sequences of state information over various timeframes for associated communication elements. Anomaly processing system 110, along with sequence prediction platform 111 and anomaly detection platform 112, can be employed to process the sequences of state information according to the desired analysis operations to detect and report anomalies in the operation of the communication elements. Operator interface system 120 can provide an interface for a user to control the operations of anomaly processing system 110 as well as receive information related to anomalies or predicted behavior of the communication elements.

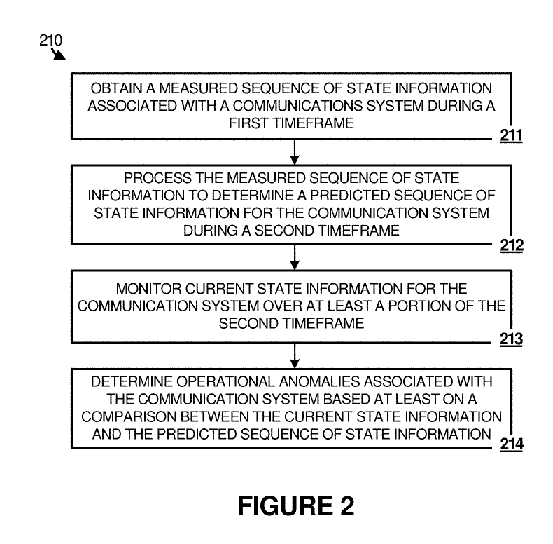

To further explore example operation of the elements of FIG. 1, flow diagram 210 is provided in FIG. 2. The operations of FIG. 2 are indicated parenthetically below. In FIG. 2, anomaly processing system 110 obtains (211) a measured sequence of state information associated with a communications system during a first timeframe. The state information associated with the communications system can include operational telemetry information retrieved from one or more communication nodes of the communication system, with the operational telemetry information comprising indications of quantities of concurrent user connections, indications of node processor utilization, indications of node memory utilization, and indications of network latency. For example, the communication system can comprise communication elements 131, among other communication elements. These communication elements can comprise various communication nodes, such as endpoints, transport nodes, traffic handling nodes, routing nodes, control nodes, among other elements.

This state information can be obtained from telemetry source 130 over link 150, and can comprise telemetry data which is processed to determine the state information. Sequences of the state information can be determined by monitoring or observing operation of communication elements 131 over various timeframes. In a specific example, a first sequence of measured state information is transferred by telemetry source 130 as sequence 140 that covers time period ΔT₁. Anomaly processing system 110 can receive sequence 140 over link 150.

Anomaly processing system 110 processes (212) the measured sequence of state information to determine a predicted sequence of state information for the communication system during a second timeframe. The predicted sequence of state information indicates a predicted behavior for the communication system during the second timeframe. In FIG. 1, sequence prediction platform 111 can receive sequence 140 over link 153 and process sequence 140 to determine predicted sequence 142 which is relevant over a second time period ΔT₂.

Sequence prediction platform 111 can process measured sequence 140 of state information using one or more machine learning algorithms. Sequence prediction platform 111 can process measured sequence 140 of state information using a recurrent neural network (RNN) process that determines the predicted sequence of state information based at least on measured sequence 140 of state information. The RNN process can be initially trained to determine the predicted sequence of state information can include using past state information observed for the communication system. Training the RNN process using the past state information can be provided by at least subdividing the past state information into a historical portion and a future portion, selecting the historical portion as an input to the RNN process, and iteratively evolving the historical portion using the RNN process until the future portion is predicted by the RNN process to within a predetermined margin of error. Other training methods and processes can be employed, and these can be included both automated and supervised training processes.

Anomaly processing system 110 monitors (213) current state information for the communication system over at least a portion of the second timeframe, where the current state information indicates an observed behavior of the communication system during the second timeframe. In some examples, anomaly detection platform 112 observes this current state information for anomaly detection. In FIG. 1, current state information 141 indicates a sequence of state information observed by telemetry source 130 over time period ΔT₂. This current state information 141 can be received by anomaly processing system 110 over link 150.

Anomaly processing system 110 determines (214) operational anomalies associated with the communication system based at least on a comparison between the current state information and the predicted sequence of state information. When differences are detected between the current state information and the predicted sequence of state information, then an anomaly might be occurring, and one or more alerts can be issued to an operator via system 120 and link 152, and the one or more alerts can provide information related to the operational anomalies.

In FIG. 1, anomaly detection platform 112 can be employed to determine when a comparison between the current state information and the predicted sequence of state information indicates deviations between the current state information and the predicted sequence of state information. Anomaly detection platform 112 can determine the operational anomalies based on a ‘distance’ of deviation between the current state information and the predicted sequence, where the distance of deviation corresponds to a severity level in the operational anomalies. This severity level can be indicated to system 120 and any associated operator. The distance referred to above can include a degree of which a deviation in state is determined, such as numerical differences in state values or state vector measurements. Other distances can be determined, such as when state information is determined in a graphical format and differences can be determined based on graphical distances between predicted graphs and observed graphs, which can be obtained by subtracting graphs or associated state data values. Other degrees or distances can be determined.

Referring back to the elements of FIG. 1, anomaly processing system 110 comprises computer processing systems and equipment which can include communication or network interfaces, as well as computer systems, microprocessors, circuitry, distributed computing systems, cloud-based systems, or some other processing devices or software systems, and which can be distributed among multiple processing devices. Examples of anomaly processing system 110 can also include software such as an operating system, logs, databases, utilities, drivers, networking software, and other software stored on a computer-readable medium. Anomaly processing system 110 can provide one or more communication interface elements which can receive data from telemetry elements, such as from telemetry source 130. Anomaly processing system 110 also provides one or more user interfaces, such as application programming interfaces (APIs), for communication with user devices to receive data selections and provide results or alerts to user devices.

Sequence prediction platform 111 and anomaly detection platform 112 each comprises various telemetry data processing modules which provide machine learning-based data processing, analysis, and prediction. In some examples, sequence prediction platform 111 and anomaly detection platform 112 are included in anomaly processing system 110, although elements of sequence prediction platform 111 and anomaly detection platform 112 can be distributed across several computing systems or devices, which can include virtualized and physical devices or systems. Sequence prediction platform 111 and anomaly detection platform 112 each can include algorithm repository elements which maintain a plurality of data processing algorithms Sequence prediction platform 111 and anomaly detection platform 112 can also include various models for evaluation of the algorithms to determine output performance across past datasets, supervised training datasets, and other test/simulation datasets. A further discussion of machine learning examples is provided below.

Operator interface system 120 comprises network interface circuitry, processing circuitry, and user interface elements. Operator interface system 120 can also include user interface systems, network interface card equipment, memory devices, non-transitory computer-readable storage mediums, software, processing circuitry, or some other communication components. Operator interface system 120 can be a computer, wireless communication device, customer equipment, access terminal, smartphone, tablet computer, mobile Internet appliance, wireless network interface device, media player, game console, or some other user computing apparatus, including combinations thereof.

Telemetry source 130 comprises one or more monitoring elements and computer-readable storage elements which observe, monitor, and store telemetry data for various operational elements, such as communication elements 131. The telemetry elements can include monitoring portions composed of hardware, software, or virtualized elements that monitor operational events and related data. Telemetry source 130 can include application monitoring services which provide a record or log of events associated with usage of associated applications or operating system elements. In other examples, telemetry source 130 can include hardware monitoring elements which provide sensor data, environmental data, user interface event data, or other information related to usage of hardware elements. In further examples, telemetry source 130 can be included within each of the communication elements 131 employed in a communication system or communication network that handles packet-based or network-provided telephony, video conferencing, audio conferencing, or other communication services.

Communication elements 131 can each include network telephony routing and control elements, and can perform network telephony routing and termination for endpoint devices. Communication elements 131 can comprise session border controllers (SBCs) in some examples which can handle one or more session initiation protocol (SIP) trunks between associated networks. Communication elements 131 can include endpoints, end user devices, or other elements in a network telephony environment. Communication elements 131 each can include computer processing systems and equipment which can include communication or network interfaces, as well as computer systems, microprocessors, circuitry, cloud-based systems, or some other processing devices or software systems, and can be distributed among multiple processing devices. Examples of communication elements 131 can include software such as an operating system, routing software, logs, databases, utilities, drivers, networking software, and other software stored on a computer-readable medium.

Communication links 150-154 each use metal, glass, optical, air, space, or some other material as the transport media. Communication links 150-154 each can use various communication protocols, such as Internet Protocol (IP), transmission control protocol (TCP), Ethernet, Hypertext Transfer Protocol (HTTP), synchronous optical networking (SONET), Time Division Multiplex (TDM), asynchronous transfer mode (ATM), hybrid fiber-coax (HFC), circuit-switched, communication signaling, wireless communications, or some other communication format, including combinations, improvements, or variations thereof. Communication links 150-154 each can be a direct link or may include intermediate networks, systems, or devices, and can include a logical network link transported over multiple physical links. In some examples, links 150-154 comprise wireless links that use the air or space as the transport media.

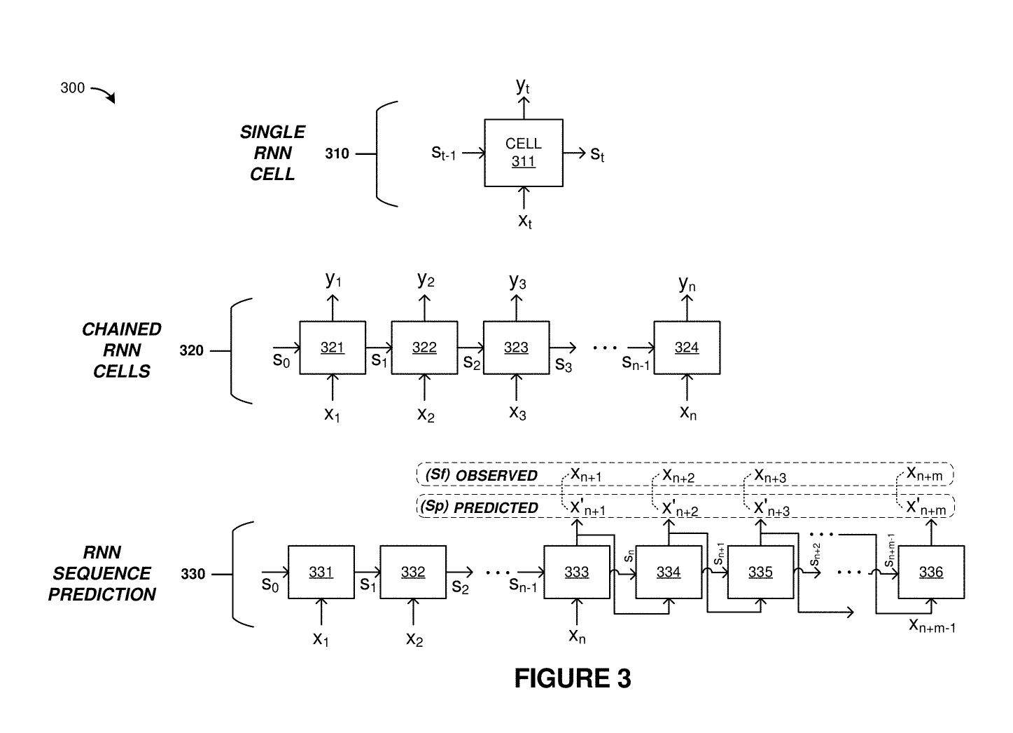

Turning now to further examples of anomaly detection and sequence prediction, FIGS. 3-5 are presented. FIGS. 3-5 include various descriptions of example recurrent neural network (RNN) elements and processes. The examples herein employ machine learning approaches for implementing the above mentioned prediction capability, such as using these recurrent neural networks. There are several variants of RNN that can be employed for the examples herein. Among these variants, two examples include Long Short Term Memory (LSTM) and Gated Recurrent Unit (GRU) variants.

In FIGS. 3-5, system measurements, such as telemetry data, are collected at evenly spaced times. For example, collected every minute, or every hour, depending on dynamics of the system. Let Sₕ=[x₁, x₂, . . . , xₙ] be a sequence of ‘n’ last measurements, where each xₜ is a whole vector of measurements at time instance t. The vector xₜ can have dimensionality that is necessary, including a single variable as a special case. In this example, a predictive capability is described that allows a system to predict a sequence of next ‘m’ measurements, S_{f}=[xₙ₊₁, xₙ₊₂, . . . , xₙ₊ₘ], based on the knowledge of the preceding sequence Sₕ. In other words, a function Predict( ) can be employed which maps the historical sequence into a future one: S_{f}=Predict(Sₕ). This example anomaly detection process can proceed as follows. Collect ‘n+m’ measurements, S=[x₁, . . . , xₙ, . . . xₙ₊ₘ]. Then, splitting the measurements into a historical sequence, Sₕ=[x₁, x₂, . . . , xₙ], and a future sequence, S_{f}=[xₙ₊₁, xₙ₊₂, . . . , xₙ₊ₘ]. A prediction is made for the last ‘m’ elements of the sequence Sₚ=Predict(Sₕ). A measurement of how far Sₚ is from S_{f} is determined, i.e. how far apart is the prediction from what is actually observed. If it is within a predetermined margin, then the system can be considered to be operating within a normal regime. If it is not within a predetermined margin, an anomaly can be declared. There are a variety of ways to measure a distance between S_{f} and Sₚ. A Euclidean distance can be measured, where a concatenation of all the vectors in the sequence into one big vector in a higher dimensional space is performed. S_{f} and Sₚ typically result in exactly the same number of dimensions, because S_{f} and Sₚ contain the same number of measurement vectors, ‘m.’

Although an anomaly score can be computed, i.e., score=Distance(S_{f}, Sₚ)=Distance(S_{f},Predict(Sₕ)). However, the use of the score can include thresholds. For example, a threshold can be set as a value corresponding to the 99th percentile of scores in a sufficiently large and representative collection of examples. One example anomaly detection might look at the whole sequence of measurements S=[x₁, . . . , xₙ, . . . xₙ₊ₘ], in order to determine how rare a given instance is relative to many others already observed, using a variety of mathematical methods.

More generally, an RNN consists of a number of chained cells. A single cell is shown on FIG. 3 in example 310. RNN is characterized by having a state, a multi-dimensional vector, denoted by s. This state evolves from each time step to the next, as the input is shown to the network. The cell takes input vector xₜ at time step t. This represents the system measurements discussed above. The cell also takes the state at the previous time step, sₜ₋₁. From these two inputs, the cell computes the output yₜ and the state for the next step, sₜ. The computation is in general non-linear, and is described with a set of update equations that involve linear algebra transformations coupled with nonlinearities that are employed in machine learning, such as sigmoid and hyperbolic tangent functions.

The cells are chained as shown in example 330 of FIG. 3 in order to process a full sequence of ‘n’ elements [x₁, . . . , xₙ]. State s₀ is an initial state that is set to small random values. This general scheme is flexible and can accommodate a variety of specific arrangement in terms of what is being learned. For this example sequence prediction task, the specific arrangement is shown in example 330 of FIG. 3. Given an observed sequence, S=[x₁, . . . , xₙ, . . . xₙ₊ₘ], it is split into a history part Sₕ=[x₁, x₂, . . . , xₙ] and a future part S_{f}=[xₙ₊₁, xₙ₊₂, . . . , xₙ₊ₘ]. The history part Sₕ is input into the RNN as shown, time step by time step, ignoring the outputs up to step n−1, with an intention to evolve the state from time step 1 to ‘n.’ At step ‘n’ the cell output, x′ₙ₊₁, is collected in lieu of the prediction for the actually observed vector xₙ₊₁. Then this predicted value x′ₙ₊₁ is used as an input to the cell in next time step. This technique is repeated for the remaining ‘m’ steps, as illustrated in example 330 of FIG. 3. As a result, an ‘m’ element long sequence Sₚ=[x′ₙ₊₁, . . . , x′ₙ₊ₘ] is determined, which represents a prediction for the actually observed sequence S_{f}=[xₙ₊₁, . . . , xₙ₊ₘ], with the prediction being based on the history in Sₕ=[x₁, . . . , xₙ].

To train the RNN process into a reliable predictor, various techniques can be employed. A large number of n+m long sequences can be collected, such as from a history of the system measurements. These can then be employed as training examples. The RNN is characterized by a set of model parameters, a.k.a., weights. A search is performed in the space of weights, using numerical optimization techniques, in order to find the set of weights that minimizes the training error, i.e., the disparity between the predicted tail of the sequence Sₚ and the actual tail S_{f}, for all the examples in the training set. In other words, supervised learning methodologies are applied to the structures shown in FIG. 3. The actual tail S_{f} serves as labels for each example in the training set. Having a model (defined as a final set of weights) trained as described can provide the desired prediction capability, i.e. the function Predict( ) that was described earlier. The model can be used as part of the anomaly detection task on sequences of measurements collected in the future, including in near-real time.

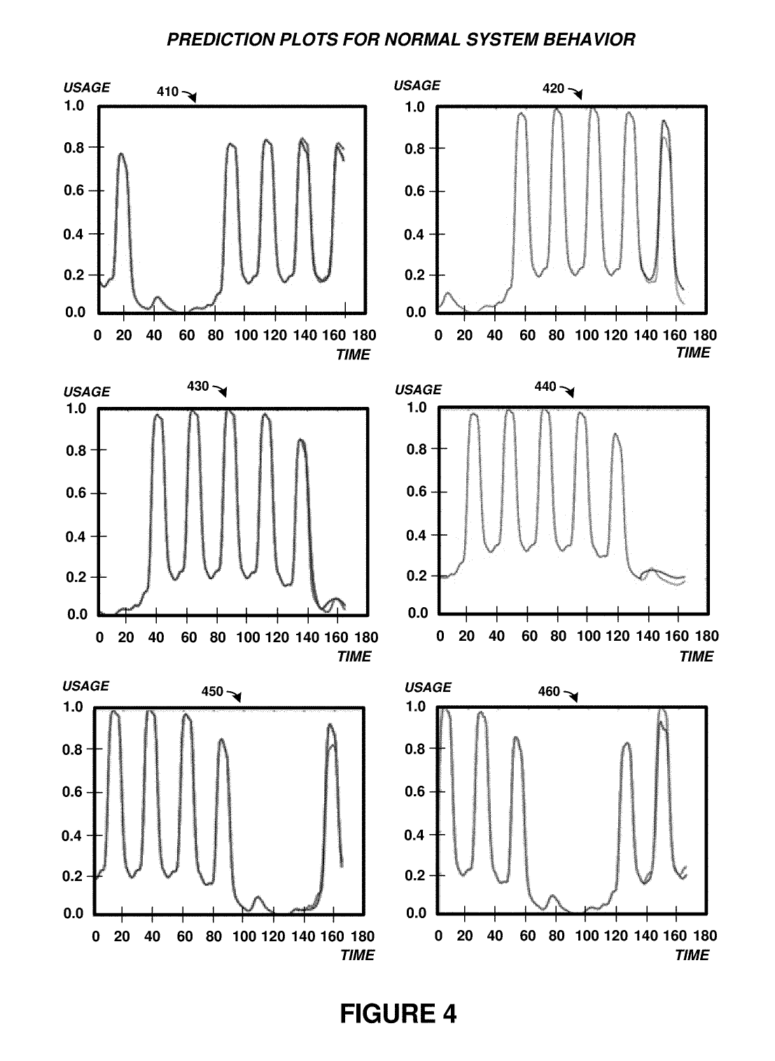

To illustrate specific examples of RNN training, FIG. 4 is presented, which can represent operation of any of the example systems discussed herein. FIG. 4 illustrates various example data sequences 410, 420, 430, 440, 450, and 460 determined from monitored telemetry of a network teleconferencing/communication service, such as Skype for Business, and a single variable “number of connected users” as a measurement vector. A time step of 1 hour is employed in FIG. 4, although other time steps can be employed. A model is trained to predict the next 30 hours (sequence of 30 measurements) given as input the past 136 hours (sequence of 136 measurements, or 5.7 days). Training data sets are assembled from several months of service usage, with each example 410, 420, 430, 440, 450, and 460 being a sequence 166 elements long. The plots on FIG. 4 show the results of prediction on a different set of examples drawn from a different year (an independent test set). One line shows the observed sequence, and another line shows the prediction generated by an RNN model for the tail of the sequence. All measurement values have been proportionally scaled to fit between 0.0 and 1.0, although other scales can be employed. As can be seen, each plot 410, 420, 430, 440, 450, and 460 in FIG. 4 shows a relatively normal operating regime of the service. Prediction matches well the actual observations. The peaks correspond to week days and valleys to nights and weekends, following a standard office work pattern. Since the prediction and actual data do not differ much, the anomaly score, being the distance from one to another, is low as well.

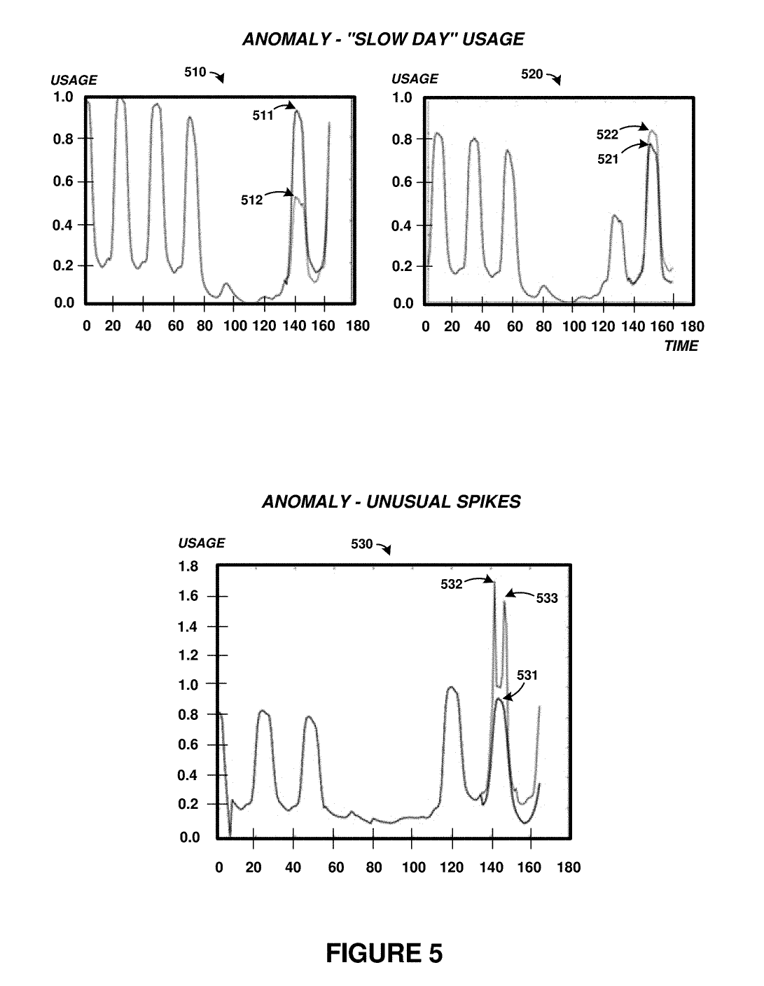

FIG. 5 shows an anomaly caught by the methods discussed herein. In plot 510 in FIG. 5, actual usage (indicated at 512) during one timeframe was significantly below the normal (predicted) levels indicated at 511. The difference between prediction 511 and actual sequence 512 for the tail of the sequence is significant in plot 510, resulting in a high anomaly score. During a subsequent timeframe in plot 510, the predicted usage and actual usage do not show a difference, and thus prediction matches the actual data well. In plot 520 in FIG. 5, actual usage (indicated at 522) during one timeframe was above the normal (predicted) levels indicated at 521. The difference between prediction 521 and actual sequence 522 for the tail of the sequence is moderate in plot 520, resulting in a medium anomaly score. FIG. 5 also shows another anomaly caught by the methods discussed herein, as noted in plot 530. In plot 530, a timeframe is shown (such as a particular workday) with two unusual spikes (532, 533) occurring at the beginning and end of the workday. Again, the prediction does not include those spikes, hence the difference between the prediction (531) and the actual tail of the sequence is large, indicating a high anomaly score. The different anomaly scores can be indicated to an operator on a normalized scale, such as 1-10, low-medium-high, or other scales. These anomaly scores can be used to indicate a severity level to an operator, which can prompt varies responses to the anomaly depending upon the severity level.

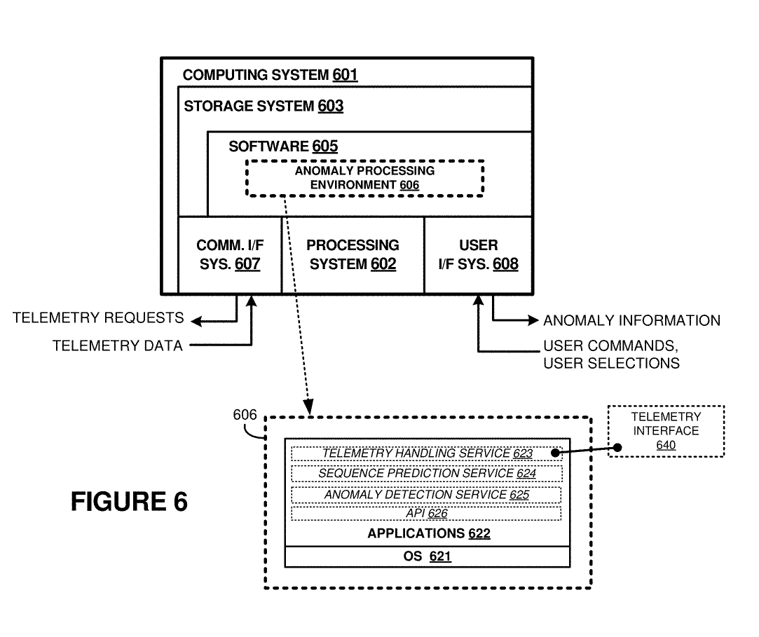

Turning now to FIG. 6, computing system 601 is presented. Computing system 601 that is representative of any system or collection of systems in which the various operational architectures, scenarios, and processes disclosed herein may be implemented. For example, computing system 601 can be used to implement any of anomaly processing system 110 or elements 111-112 of FIG. 1. Examples of computing system 601 include, but are not limited to, server computers, cloud computing systems, distributed computing systems, software-defined networking systems, computers, desktop computers, hybrid computers, rack servers, web servers, cloud computing platforms, and data center equipment, as well as any other type of physical or virtual server machine, and other computing systems and devices, as well as any variation or combination thereof.

Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607, and user interface system 608. Processing system 602 is operatively coupled with storage system 603, communication interface system 607, and user interface system 608.

Processing system 602 loads and executes software 605 from storage system 603. Software 605 includes anomaly processing environment 606, which is representative of the processes discussed with respect to the preceding Figures. When executed by processing system 602 to enhance anomaly detection and telemetry prediction processing, software 605 directs processing system 602 to operate as described herein for at least the various processes, operational scenarios, and environments discussed in the foregoing implementations. Computing system 601 may optionally include additional devices, features, or functionality not discussed for purposes of brevity.

Referring still to FIG. 6, processing system 602 may comprise a microprocessor and processing circuitry that retrieves and executes software 605 from storage system 603. Processing system 602 may be implemented within a single processing device, but may also be distributed across multiple processing devices or sub-systems that cooperate in executing program instructions. Examples of processing system 602 include general purpose central processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, resistive memory, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device, but may also be implemented across multiple storage devices or sub-systems co-located or distributed relative to each other. Storage system 603 may comprise additional elements, such as a controller, capable of communicating with processing system 602 or possibly other systems.

Software 605 may be implemented in program instructions and among other functions may, when executed by processing system 602, direct processing system 602 to operate as described with respect to the various operational scenarios, sequences, and processes illustrated herein. For example, software 605 may include program instructions for implementing the anomaly processing environments and platforms discussed herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software or other application software, in addition to or that include anomaly processing environment 606. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to facilitate anomaly detection and operational state prediction in communication systems and various computing systems. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Anomaly processing environment 606 includes one or more software elements, such as OS 621 and applications 622. These elements can describe various portions of computing system 601 with which users, operators, telemetry elements, machine learning environments, or other elements, interact. For example, OS 621 can provide a software platform on which applications 622 are executed and provide for detecting performance anomalies in a communication system, obtaining a measured sequence of state information associated with the communications system during a first timeframe, processing the measured sequence of state information to determine a predicted sequence of state information for the communication system during a second timeframe, monitoring current state information for the communication system over at least a portion of the second timeframe, and determining operational anomalies associated with the communication system based at least on a comparison between the current state information and the predicted sequence of state information.

In one example, telemetry handling service 623 can obtain measured sequences of state information associated with a communications system, receive datasets from telemetry elements or other data sources, store various status, telemetry, or state data for processing in storage system 603, and transfer anomaly information to users or operators. In FIG. 6, telemetry interface 640 can be provided which communicates with various telemetry devices or monitored communication elements. Portions of telemetry interface can be included in elements of communication interface 607, such as in network interface elements. Sequence prediction service 624 can process measured sequences of state data compiled from different telemetry sources and process the measured sequences of state information to determine predicted sequences of state information. Various machine learning algorithms, such as RNN algorithms, can be employed in sequence prediction server 624. These machine learning algorithms can be employed in computing system 601 or computing system 601 can communicate with other computing systems that house the various machine learning algorithms. Anomaly detection service 625 monitors current state information, and determines operational anomalies based at least on a comparison between the current state information and the predicted sequences of state information. API 626 provides user interface elements for interaction and communication with a user or operator, such as through user interface system 608. API 626 can comprise one or more routines, protocols, and interface definitions which a user or operator can employ to deploy the services of anomaly processing environment 606, among other services.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. Physical or logical elements of communication interface system 607 can receive data from telemetry sources, transfer telemetry data and control information between one or more machine learning algorithms, and interface with a user to receive data selections and provide anomaly alerts, and information related to anomalies, among other features.

User interface system 608 is optional and may include a keyboard, a mouse, a voice input device, a touch input device for receiving input from a user. Output devices such as a display, speakers, web interfaces, terminal interfaces, and other types of output devices may also be included in user interface system 608. User interface system 608 can provide output and receive input over a network interface, such as communication interface system 607. In network examples, user interface system 608 might packetize display or graphics data for remote display by a display system or computing system coupled over one or more network interfaces. Physical or logical elements of user interface system 608 can receive data or data selection information from operators, and provide anomaly alerts or information related to predicted system behavior to operators. User interface system 608 may also include associated user interface software executable by processing system 602 in support of the various user input and output devices discussed above. Separately or in conjunction with each other and other hardware and software elements, the user interface software and user interface devices may support a graphical user interface, a natural user interface, or any other type of user interface. In some examples, portions of API 626 are included in elements of user interface system 608.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transmission control protocol (TCP), and the user datagram protocol (UDP), as well as any other suitable communication protocol, variation, or combination thereof. In some examples, portions of API 626 are included in elements of user interface system 608.

Certain inventive aspects may be appreciated from the foregoing disclosure, of which the following are various examples.

### EXAMPLE 1

A method of detecting performance anomalies in a communication system, the method comprising obtaining a measured sequence of state information associated with the communications system during a first timeframe, processing the measured sequence of state information to determine a predicted sequence of state information for the communication system during a second timeframe, monitoring current state information for the communication system over at least a portion of the second timeframe, and determining operational anomalies associated with the communication system based at least on a comparison between the current state information and the predicted sequence of state information.

### EXAMPLE 2

The method of Example 1, further comprising determining when the comparison between the current state information and the predicted sequence of state information indicates deviations between the current state information and the predicted sequence of state information, and determining the operational anomalies based on a distance of deviation between the current state information and the predicted sequence.

### EXAMPLE 3

The method of Examples 1-2, where the distance of deviation corresponds to a severity level in the operational anomalies.

### EXAMPLE 4

The method of Examples 1-3, further comprising indicating one or more alerts to an operator system that provide information related to the operational anomalies.

### EXAMPLE 5

The method of Examples 1-4, further comprising processing the measured sequence of state information using a recurrent neural network (RNN) process that determines the predicted sequence of state information based at least on the measured sequence of state information.

### EXAMPLE 6

The method of Examples 1-5, where the RNN process is trained to determine the predicted sequence of state information using past state information for the communication system.

### EXAMPLE 7

The method of Examples 1-6, further comprising training the RNN process using past state information observed for the communication system by at least subdividing the past state information into a historical portion and a future portion, selecting the historical portion as an input to the RNN process, and iteratively evolving the historical portion using the RNN process until the future portion is predicted by the RNN process to within a predetermined margin of error.

### EXAMPLE 8

The method of Examples 1-7, where the predicted sequence of state information indicates a predicted behavior for the communication system during the second timeframe, and where the current state information indicates an observed behavior of the communication system during the second timeframe.

### EXAMPLE 9

The method of Examples 1-8, where the state information associated with the communications system comprises operational telemetry information retrieved from one or more communication nodes of the communication system, the operational telemetry information comprising one or more indications of concurrent user connections, node processor utilization, node memory utilization, and network latency.

### EXAMPLE 10

An apparatus comprising one or more computer readable storage media, and program instructions stored on the one or more computer readable storage media. The program instructions, when executed by a processing system, direct the processing system to at least obtain a measured sequence of state information associated with the communications system during a first timeframe, process the measured sequence of state information to determine a predicted sequence of state information for the communication system during a second timeframe, monitor current state information for the communication system over at least a portion of the second timeframe, and determine operational anomalies associated with the communication system based at least on a comparison between the current state information and the predicted sequence of state information.

### EXAMPLE 11

The apparatus of Example 10, comprising further program instructions, when executed by the processing system, direct the processing system to at least determine when the comparison between the current state information and the predicted sequence of state information indicates deviations between the current state information and the predicted sequence of state information, and determine the operational anomalies based on a distance of deviation between the current state information and the predicted sequence.

### EXAMPLE 12

The apparatus of Examples 10-11, where the distance of deviation corresponds to a severity level in the operational anomalies.

### EXAMPLE 13

The apparatus of Examples 10-12, comprising further program instructions, when executed by the processing system, direct the processing system to at least indicate one or more alerts to an operator system that provide information related to the operational anomalies.

### EXAMPLE 14

The apparatus of Examples 10-13, comprising further program instructions, when executed by the processing system, direct the processing system to at least process the measured sequence of state information using a recurrent neural network (RNN) process that determines the predicted sequence of state information based at least on the measured sequence of state information.

### EXAMPLE 15

The apparatus of Examples 10-14, where the RNN process is trained to determine the predicted sequence of state information using past state information for the communication system.

### EXAMPLE 16

The apparatus of Examples 10-15, comprising further program instructions, when executed by the processing system, direct the processing system to at least train the RNN process using past state information observed for the communication system by at least subdividing the past state information into a historical portion and a future portion, selecting the historical portion as an input to the RNN process, and iteratively evolving the historical portion using the RNN process until the future portion is predicted by the RNN process to within a predetermined margin of error.

### EXAMPLE 17

The apparatus of Examples 10-16, where the predicted sequence of state information indicates a predicted behavior for the communication system during the second timeframe, and where the current state information indicates an observed behavior of the communication system during the second timeframe.

### EXAMPLE 18

The apparatus of Examples 10-17, where the state information associated with the communications system comprises operational telemetry information retrieved from one or more communication nodes of the communication system, the operational telemetry information comprising one or more indications of concurrent user connections, node processor utilization, node memory utilization, and network latency.

### EXAMPLE 19

A method of processing telemetry data, the method comprising obtaining an initial sequence of telemetry data measured during a first timeframe, processing the initial sequence of telemetry data to determine a predicted sequence of telemetry data during a second timeframe, observing current telemetry data over at least a portion of the second timeframe, determining deviations between the predicted sequence of telemetry data and the current telemetry data, and reporting the deviations as one or more alerts indicating operational anomalies for the current telemetry data.

### EXAMPLE 20

The method of Example 19, further comprising processing the initial sequence of telemetry data using a recurrent neural network (RNN) process that determines the predicted sequence of telemetry data based at least on the initial sequence of telemetry data, where the RNN process is trained using past telemetry data by at least subdividing the past telemetry data into a historical portion and a future portion, selecting the historical portion as an input to the RNN process, and iteratively evolving the historical portion using the RNN process until the future portion is predicted by the RNN process to within a predetermined margin of error.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of detecting performance anomalies in a communication system, the method comprising:
obtaining a measured sequence of state information associated with the communications system during a first timeframe;
processing the measured sequence of state information to determine a predicted sequence of state information for the communication system during a second timeframe;
monitoring current state information for the communication system over at least a portion of the second timeframe;
determining operational anomalies associated with the communication system based at least on a comparison between the current state information and the predicted sequence of state information.

2. The method of claim 1, further comprising:
determining when the comparison between the current state information and the predicted sequence of state information indicates deviations between the current state information and the predicted sequence of state information;
determining the operational anomalies based on a distance of deviation between the current state information and the predicted sequence.

3. The method of claim 2, wherein the distance of deviation corresponds to a severity level in the operational anomalies.

4. The method of claim 1, further comprising:
indicating one or more alerts to an operator system that provide information related to the operational anomalies.

5. The method of claim 1, further comprising:
processing the measured sequence of state information using a recurrent neural network (RNN) process that determines the predicted sequence of state information based at least on the measured sequence of state information.

6. The method of claim 5, wherein the RNN process is trained to determine the predicted sequence of state information using past state information for the communication system.

7. The method of claim 5, further comprising:
training the RNN process using past state information observed for the communication system by at least subdividing the past state information into a historical portion and a future portion, selecting the historical portion as an input to the RNN process, and iteratively evolving the historical portion using the RNN process until the future portion is predicted by the RNN process to within a predetermined margin of error.

8. The method of claim 1, wherein the predicted sequence of state information indicates a predicted behavior for the communication system during the second timeframe, and wherein the current state information indicates an observed behavior of the communication system during the second timeframe.

9. The method of claim 1, wherein the state information associated with the communications system comprises operational telemetry information retrieved from one or more communication nodes of the communication system, the operational telemetry information comprising one or more indications of concurrent user connections, node processor utilization, node memory utilization, and network latency.

10. An apparatus comprising:
one or more computer readable storage media;
program instructions stored on the one or more computer readable storage media that, when executed by a processing system, direct the processing system to at least:
obtain a measured sequence of state information associated with the communications system during a first timeframe;
process the measured sequence of state information to determine a predicted sequence of state information for the communication system during a second timeframe;
monitor current state information for the communication system over at least a portion of the second timeframe;
determine operational anomalies associated with the communication system based at least on a comparison between the current state information and the predicted sequence of state information.

11. The apparatus of claim 10, comprising further program instructions, when executed by the processing system, direct the processing system to at least:
determine when the comparison between the current state information and the predicted sequence of state information indicates deviations between the current state information and the predicted sequence of state information;
determine the operational anomalies based on a distance of deviation between the current state information and the predicted sequence.

12. The apparatus of claim 11, wherein the distance of deviation corresponds to a severity level in the operational anomalies.

13. The apparatus of claim 10, comprising further program instructions, when executed by the processing system, direct the processing system to at least:
indicate one or more alerts to an operator system that provide information related to the operational anomalies.

14. The apparatus of claim 10, comprising further program instructions, when executed by the processing system, direct the processing system to at least:
process the measured sequence of state information using a recurrent neural network (RNN) process that determines the predicted sequence of state information based at least on the measured sequence of state information.

15. The apparatus of claim 14, wherein the RNN process is trained to determine the predicted sequence of state information using past state information for the communication system.

16. The apparatus of claim 14, comprising further program instructions, when executed by the processing system, direct the processing system to at least:
train the RNN process using past state information observed for the communication system by at least subdividing the past state information into a historical portion and a future portion, selecting the historical portion as an input to the RNN process, and iteratively evolving the historical portion using the RNN process until the future portion is predicted by the RNN process to within a predetermined margin of error.

17. The apparatus of claim 10, wherein the predicted sequence of state information indicates a predicted behavior for the communication system during the second timeframe, and wherein the current state information indicates an observed behavior of the communication system during the second timeframe.

18. The apparatus of claim 10, wherein the state information associated with the communications system comprises operational telemetry information retrieved from one or more communication nodes of the communication system, the operational telemetry information comprising one or more indications of concurrent user connections, node processor utilization, node memory utilization, and network latency.

19. A method of processing telemetry data, the method comprising:
obtaining an initial sequence of telemetry data measured during a first timeframe;
processing the initial sequence of telemetry data to determine a predicted sequence of telemetry data during a second timeframe;
observing current telemetry data over at least a portion of the second timeframe;
determining deviations between the predicted sequence of telemetry data and the current telemetry data; and
reporting the deviations as one or more alerts indicating operational anomalies for the current telemetry data.

20. The method of claim 19, further comprising:
processing the initial sequence of telemetry data using a recurrent neural network (RNN) process that determines the predicted sequence of telemetry data based at least on the initial sequence of telemetry data, wherein the RNN process is trained using past telemetry data by at least subdividing the past telemetry data into a historical portion and a future portion, selecting the historical portion as an input to the RNN process, and iteratively evolving the historical portion using the RNN process until the future portion is predicted by the RNN process to within a predetermined margin of error.
